(19) United States
(12) Patent Application Publication
(10) Pub. No.: US 2025/0005722 A1
(43) Pub. Date: Jan. 2, 2025

(54) IMAGE PROCESSING METHOD AND APPARATUS, PHOTOGRAPHING DEVICE, AND READABLE STORAGE MEDIUM

(71) Applicant: SZ DJI TECHNOLOGY CO., LTD., Shenzhen (CN)

(72) Inventors: Qi ZHANG, Shenzhen (CN); Dan QIU, Shenzhen (CN)

(21) Appl. No.: 18/708,849

(22) PCT Filed: Aug. 27, 2021
(86) PCT No.: PCT/CN2021/115115

§ 371 Date: May 9, 2024

(51) Int. Cl. G06T 5/77; G06V 10/26; G06V 10/44; G06V 10/60; G06V 10/98; G06V 40/10

(52) U.S. Cl. CPC G06T 5/77; G06V 10/26; G06V 10/443; G06V 10/60; G06V 10/993; G06V 40/10; G06T 2207/30196

(57) ABSTRACT

An image processing method includes obtaining an original image, and identifying a shadow area of a target object in the original image. The target object includes at least one of a photographing device or a support apparatus of the photographing device. The method further includes eliminating the shadow area of the target object in the original image.

### TECHNICAL FIELD

The present disclosure generally relates to the field of image processing technology, and, more particularly, to an image processing method, an image processing apparatus, a photographing device, and a computer-readable storage medium.

### BACKGROUND

As people's photographing requirements become higher and higher, various camera products are constantly improving and innovating. A camera can also be combined with other accessories to implement applications in different scenarios, such as selfie sticks, headsets, or hand-mounted devices for photographing from more angles. However, when the camera is used with other accessories, such as when using a selfie stick to support the camera during photographing, the selfie stick often appears in the photographed image. Especially when there is light, the shadow of the selfie stick will also appear in the photographed image. This makes the photographed image appear abrupt and unrealistic, and also destroys the beauty of the photographed image.

### SUMMARY

The present disclosure provides an image processing method, an image processing apparatus, a photographing device, and a computer-readable storage medium.

One aspect of the present disclosure provides an image processing method. The image processing method includes: obtaining an original image; identifying a shadow area of a target object in the original image, where the target object includes at least one of a photographing device and a support apparatus of the photographing device; and eliminating the shadow area of the target object in the original image.

Another aspect of the present disclosure provides an image processing apparatus. The image processing apparatus includes a processor. The processor is configured to: obtain an original image; identify a shadow area of a target object in the original image, where the target object includes at least one of a photographing device or a support apparatus of the photographing device; and eliminate the shadow area of the target object in the original image.

Another aspect of the present disclosure provides a photographing device. The photographing device includes an image processing apparatus provided by various embodiments of the present disclosure.

Another aspect of the present disclosure provides a computer-readable storage medium. The computer-readable storage medium is configured to store computer instructions. When the computer instructions are executed by a processor, an image processing method provided by various embodiments of the present disclosure is implemented.

In the image processing method, the image processing apparatus, the photographing device, and the computer-readable storage medium, by eliminating the shadow area of the target object in the original image where the target object includes at least one of the photographing device or the support apparatus of the photographing device, the image without the shadow area of the target object may be obtained. Therefore, the aesthetics of the image may be improved when the original image does not include the target object, and the image may not appear obtrusive. Also, a non-selfie image photographing effect may be achieved.

Additional aspects and advantages of the present disclosure will be set forth in part in the description which follows, and in part will be obvious from the description, or may be learned by practice of the present disclosure.

### BRIEF DESCRIPTION OF THE DRAWINGS

To more clearly illustrate the technical solutions of the embodiments of the present disclosure, the drawings needed to be used in the description of the embodiments will be briefly introduced below.

FIG. 1 is a flowchart of an image processing method consistent with the present disclosure.

FIG. 2 is a schematic diagram showing a scenario of an image processing method consistent with the present disclosure.

FIG. 3 is a modular diagram of an image processing apparatus consistent with the present disclosure.

FIG. 4 to FIG. 10 are flowcharts of image processing methods consistent with the present disclosure.

FIG. 11 is a schematic diagram showing a scenario of an image processing method consistent with the present disclosure.

FIG. 12 to FIG. 13 are flowcharts of image processing methods consistent with the present disclosure.

### NUMERICAL REFERENCES

100—Image processing apparatus 101—Processor
300—Original image 301—Shadow area

### DETAILED DESCRIPTION OF THE EMBODIMENTS

Specific embodiments of the present disclosure are hereinafter described with reference to the accompanying drawings. The same or similar reference numbers represent the same or similar elements or elements with the same or similar functions. The embodiments described below in connection with drawings are examples and are merely used to explain the disclosure, but should not be understood as to limit the disclosure.

In the present disclosure, the terms “first” and “second” are only used for descriptive purposes and should not be understood as indicating or implying the relative importance or implicitly indicating the quantity of the indicated technical features. Features associated with “first” and “second” may explicitly or implicitly include one or more of the described features. In the present disclosure, “plurality” means two or more, unless otherwise expressly and specifically limited.

In the present disclosure, it should be noted that, unless otherwise clearly stated and limited, the terms “installation,” “coupling,” or “connection” should be understood in a broad sense. For example, it may be a fixed connection, a detachable connection, or a connection in one piece. The connection may be mechanical or electrical. The connection may be a direct connection or an indirect connection through an intermediary. It can be an internal connection between two elements or an interaction between two elements. For those of ordinary skill in the art, the specific meanings of the above terms in the present disclosure can be understood according to specific circumstances.

The following disclosure provides many different embodiments or examples for implementing the various structures of the present disclosure. To simplify the description of the present disclosure, the components and arrangements of specific examples are described below. Of course, they are merely examples and are not intended to limit the scope of the present disclosure. Further, the reference numbers and/or reference letters may be repeated in different examples. Such repetition is for the purposes of simplicity and clarity and does not by itself indicate a relationship between the various embodiments and/or arrangements discussed. In addition, the present disclosure provides examples of various specific processes and materials, but those of ordinary skill in the art will recognize the application of other processes and/or the use of other materials.

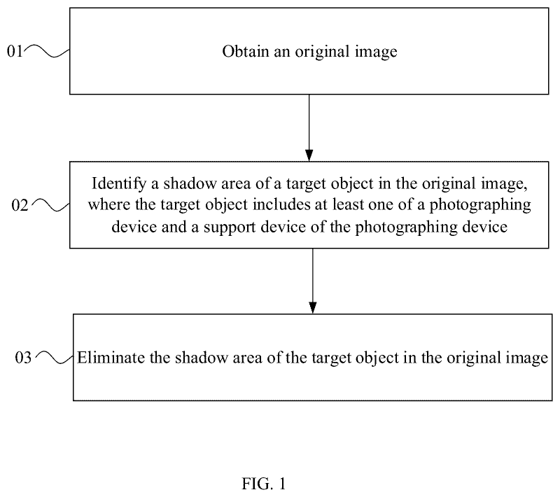

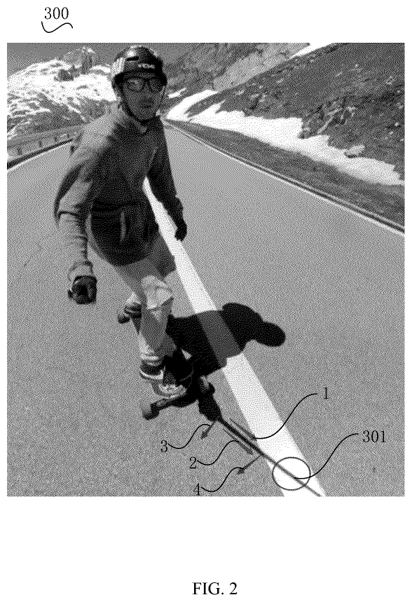

The present disclosure provides an image processing method. As shown in FIG. 1 and FIG. 2, in one embodiment, the image processing method includes:
01: obtaining an original image 300;
02: identifying a shadow area 301 of a target object in the original image 300, where the target object includes at least one of a photographing device or a support apparatus of the photographing device; and
03: eliminating the shadow area 301 of the target object in the original image 300.

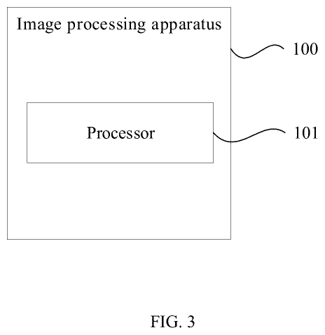

The present disclosure also provides an image processing apparatus 100. As shown in FIG. 3, in one embodiment, the image processing apparatus 100 includes a processor 101. The image processing method provided by various embodiments of the present disclosure may be implemented by the image processing apparatus 100 provided by the present disclosure. 01, 02 and 03 may all be implemented by the processor 101. That is, the processor 101 may be configured to: obtain the original image 300; identify the shadow area 301 of the target object in the original image 300, where the target object includes at least one of the photographing device or the support apparatus of the photographing device; and eliminate the shadow area 301 of the target object in the original image 300.

In the image processing apparatus 100 and the image processing method provided by the present disclosure, by eliminating the shadow area 301 of the target object in the original image 300 where the target object includes at least one of the photographing device or the support apparatus of the photographing device, an image that does not include the shadow area 301 of the target object may be obtained, such that the aesthetics of the picture may be improved when the original image 300 does not contain the target object. Also, the photographing image may not appear obtrusive, and a non-selfie photographing effect may be achieved. The original image may include an image in an electronic form captured by various photographing devices that are able to take photos in electronic form, such as sports cameras, mobile phones, ordinary cameras, or professional cameras. The original image may be in PSD format, PSB format, JPG format, GIF format, PNG format, JPEG format, BMP format, RAW format, etc. The “original” in “original image” may mean that it has not gone through the process of eliminating the shadow area of the target object in the embodiments of the present disclosure, and does not mean that it has not gone through other processing processes such as overall image processing. The overall image processing may include, for example, overall rendering, image encoding, image compression, etc.

As people's photographing requirements become higher and higher, various camera products are constantly improving and innovating. The photographing device may be combined with the support apparatus to implement sports photographing or selfie photographing, for different scenarios.

In one embodiment, the photographing device may be a sports camera. The sports camera may be a portable, small, dustproof, shockproof, or waterproof photographing device. Users may use the sports camera in some extreme sports. The sports camera is able to work stably in many sports environments, such as high altitude environments, deep water environments, sports environments, etc. In other words, the sports camera is able to photograph not only in normal environments but also in some extreme sports. The photographing device may be used with the support apparatus. The support apparatus may include, but is not limited to, a selfie stick, a head-mounted device, a hand-mounted device, or other devices that are able to support the photographing device. The support apparatus cooperating with the photographing device may not only facilitate photographing, but also enable more stable photographing from more angles.

In another embodiment, the photographing device may be a sports camera, and the support apparatus may be a selfie stick. The user may use the sports camera and the selfie stick to take selfies of himself while skateboarding. In yet another embodiment, the photographing device may be a waterproof camera and the support apparatus may be a head-mounted device. The user may use the waterproof camera and the head-mounted device to capture underwater scenery while diving.

In another embodiment, the photographing device may be a mobile phone, and the support apparatus may be a selfie stick. In another embodiment, the photographing device may be a gimbal camera or a mobile phone mounted on a gimbal, and the support apparatus may be a selfie stick provided with a gimbal handle.

When the photographing device and the support apparatus of the photographing device are actually used, the image of the support apparatus may often enter the original image 300. To have better photographing content, the image of the support apparatus may be eliminated from the original image 300 by performing feature recognition on the support apparatus. However, the photographing device and support apparatus of the photographing device may be also prone to form shadows caused by sunlight, lamp light or other light. When photographing, at least one of the shadow of the photographing device or the shadow of the support apparatus may appear in the original image 300. That is, the shadow area of the target object in the original image 300 may include at least one of the shadow area of the photographing device or the shadow area of the target object. That is, the shadow area of the target object in the original image 300 may include the shadow area of the photographing device, or may include the shadow area of the support apparatus of the photographing device, or may include the shadow area of the photographing device and the shadow area of the support apparatus. In one embodiment shown in FIG. 2, for example, the shadow area of the target object in the original image 300 includes the shadow area of the selfie stick. Since the shadow of the support apparatus changes in various ways due to different light conditions, it cannot be easily identified and may remain in the photographed image. Therefore, the shadow of the support apparatus may appear rather abrupt and unrealistic, and also destroy the beauty of the photographed image.

In the image processing method and image processing apparatus provided by the present disclosure, the shadow area 301 of the target object in the original image 300 may be identified after acquiring the original image 300. And then, the shadow area 301 of the target object in the original image 300 may be eliminated. The aesthetics of the image may be improved, such that the image does not appear obtrusive, and a non-selfie photographing effect may be realized.

The type of the target object may be determined in advance (for example, the type of the target object may be determined by performing feature extraction on the target object, where the feature extraction may be achieved through machine learning, neural networks, big data, etc.), such as the photographing device or the support apparatus of the photographing device. The shadow area 301 of the photographing device or the support apparatus of the photographing device in the original image 300 may be determined, and then the shadow area 301 may be eliminated.

In some embodiments, the processor 101 may be integrated into a processing chip. In addition to the processor, the processing chip may also be integrated with a memory, a communication module, a power module, etc. In some embodiments, the processor 101 may be a central processing unit (CPU), a graphics processing unit (GPU), another general-purpose processor, a digital signal processor (DSP), an application-specific integrated circuit (ASIC), a field-programmable gate array (FPGA) or other programmable logic device, a discrete gate or transistor logic device, a discrete hardware component, etc.

In one embodiment, the image processing apparatus 100 may be a device independent of the photographing device, and the image processing apparatus 100 may transmit data or signals with the photographing device wired or wirelessly. The image processing apparatus 100 may include, but is not limited to, a mobile phone, a tablet computer, a personal computer, another photographing device, or a support apparatus. The image processing apparatus 100 may be integrated with the photographing device, such that it may be easily carried by the user. The processor 101 of the image processing apparatus 100 may be a processor of the photographing device, or may be another processor different from the processor of the photographing device. The image captured by the photographing device may be directly displayed on the display screen of the photographing device after being processed by the image processing apparatus 100.

One embodiment where the target object includes the photographing device and the support apparatus of the photographing device will be used as an example to illustrate the present disclosure, and it does not limit the target object and the scope of the present disclosure.

In some embodiments, 01 may include obtaining the original image 300 from the photographing device.

In some embodiments, the above steps may be implemented by the image processing apparatus 100. That is, the processor 101 may be configured to obtain the original image 300 from the photographing device. Therefore, the original image 300 may be obtained simply and quickly, and the image in the photographing device may be sent to the image processing apparatus 100, making the image processing apparatus 100 more flexible in how to obtain the original image 300.

In one embodiment, the user may utilize the photographing device to take the original image 300, and the photographing device may be connected with the image processing apparatus 100 wired or wirelessly. The processor 101 may receive the image captured by the photographing device and eliminate the shadow area 301 of the photographing device and the support apparatus of the photographing device.

Wireless connection methods may include but are not limited to one or a combination of Bluetooth, infrared, WIFI (Wireless Fidelity), ZigBee, etc., to achieve wireless communication, which is not specifically limited here. The photographing device may send the original image 300 to the image processing apparatus 100 with the processor 101. The processor 101 may obtain the original image 300 from the image processing apparatus 100, identify the shadow area 301 of the photographing device and the target object in the original image 300, and then eliminate the shadow area 301 of the photographing device and the support apparatus of the photographing device in the original image 300.

The photographing device may include, but is not limited to, a camera, a sports camera, a mobile phone, a camera watch, a tablet or other devices. In some embodiments, the photographing device and the support apparatus may be assembled together, such as, for example, a mobile phone installed on a selfie stick, a sports camera screwed to the selfie stick, or a mobile phone installed on the selfie stick provided with the gimbal handle.

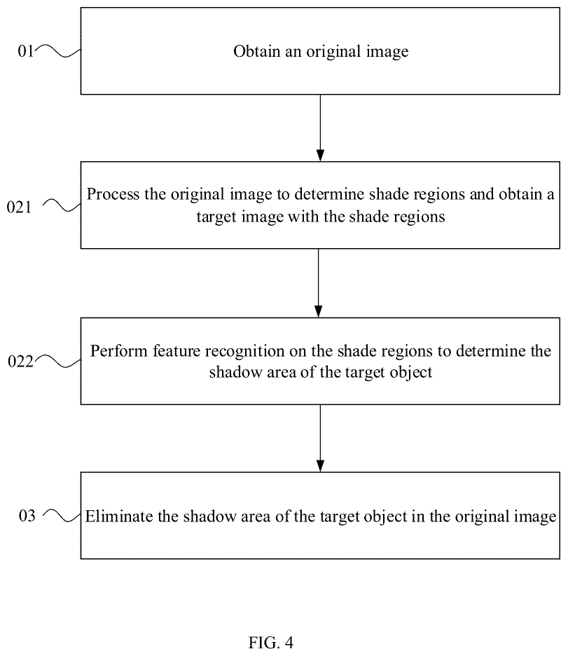

In some embodiments shown in FIG. 4, 02 includes:
021: processing the original image 300 to determine the shade regions and obtain a target image with the shade regions; and
022: performing feature recognition on the shade regions to determine the shadow area 301 of the target object.

In some embodiments, the above steps may be implemented by the image processing apparatus 100. That is, the processor 101 may be configured to: process the original image 300 to determine the shade regions and obtain the target image with the shade regions; and perform the feature identification on the shade regions to determine the shadow area 301 of the target object. Therefore, by first obtaining the target image including only the shade regions and then identifying the shadow area 301 of the target object through the feature recognition, the shadow area 301 of the target object may be quickly and accurately obtained, thereby eliminating the shadow area 301 and making the picture aesthetically pleasing.

In one embodiment, the user may use the image processing apparatus 100 to obtain the original image 300, and process the original image 300 to determine the shade regions and obtain the target image with the shade regions, after obtaining the original image 300. The target image may be an image including all shade regions in the original image 300. Therefore, the target image may include the shadow area 301 of the target object, and may also include other shade regions. The feature recognition may be performed on all shade regions in the target image, thereby determining the shadow area 301 of the target object. The feature recognition may be achieved through machine learning, neural networks, big data, etc.

In one embodiment, the target object may include the photographing device and the support apparatus of the photographing device. The photographing device may be a sports camera, and the support apparatus may be a selfie stick. The selfie stick and the sports camera on the selfie stick may have corresponding features. The hand of the user holding the selfie stick may also have corresponding features. Therefore, the feature recognition of the shade regions may be realized through machine learning, neural network, or big data, to determine the shadow area 301 of the selfie stick and the sports camera from the shade regions. The feature recognition of shade regions may be achieved more accurately and quickly through machine learning, neural networks or big data.

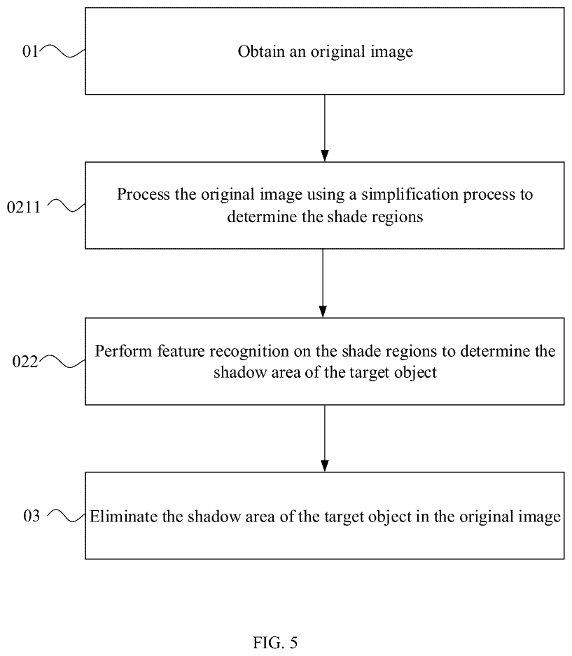

In some embodiments, as shown in FIG. 5, 021 includes:
0211: using a simplification process to process the original image 300 to determine the shade regions.

In some embodiments, the above steps may be implemented by the image processing apparatus 100. That is, the processor 101 may be configured to: use the simplification process to process the original image 300 to determine the shade regions. Therefore, by the simplification process, the shade regions of the original image 300 may be obtained. The simplification process may reduce the computing amount for obtaining the shade regions, and reduce the time length of the process.

The simplification process may determine all shade regions in the original image 300 through the simplification process, such that the shade regions and non-shade regions are clearly separated, which facilitates the generation of the target image that only retains all shade regions. The simplified process may be able to determine all shade regions 301 in the original image 300 more simply and quickly.

In some embodiments, the simplification process includes a binarization process.

The simplification process may be a binarization process, that is, the original image 300 may be binarized to obtain the target image. In one embodiment, the binarization process may be to convert the grayscale values of the original image 300 into only 0 (black) and 255 (white). That is, a black or white image may be generated through the binarization process. By setting a threshold, all pixels with a grayscale value greater than the threshold may be set to black, and all pixels with a grayscale value less than the threshold may be set to white, to finish the binarization processing of the original image 300. For example, a threshold may be set, and all pixels with a grayscale value greater than the threshold may be set to black. That is, pixels with a grayscale value greater than the threshold may be understood as pixels in the shade regions. Therefore, the original image 300 may be quickly processed to determine the shade regions.

By obtaining the binary image through the binarization process, contours in the binary image may be searched for, and the contours may be filtered according to the features of the target object. The method of filtering the contours may include saving a contour when the area of the contour is less than a certain threshold and assigning 0 (black) to all pixel values (such as grayscale values) in the contour that meet the saving condition. The method for finding contours in binary images may include but is not limited to, an internal point hollowing method, a boundary tracking method, etc.

In some embodiments, 022 may include:
performing the feature recognition on the entire area of the target image to determine the shadow area 301 of the target object.

In some embodiments, the above steps may be implemented by the image processing apparatus 100. That is, the processor 101 may be configured to: perform the feature recognition on the entire area of the target image to determine the shadow area 301 of the target object. The feature recognition on the entire area of the target image may be able to search for the shadow area 301 of the target object in a maximum range, avoiding omissions during the feature recognition and making the feature recognition more accurate.

The feature recognition may be performed on the entire area of the target image to determine the shadow area 301 of the target object. The feature recognition may be achieved through deep learning, neural networks, big data or other methods. Deep learning is an important breakthrough in the field of artificial intelligence. Deep learning may not only process target images, but also analyze and process target videos. Deep learning may be able to automatically analyze and obtain rules from data or previous experience in processing target images, conduct modeling, and use the rules to perform feature matching on the target image that currently needs to be processed. Therefore, deep learning may be used as a means to solve the problem of feature recognition of the entire area of the target image to determine the shadow area 301 of the target object.

Neural Network (NN) is also called artificial neural network (ANN) or neural-like network. Neural network is a computing model that imitates the structure and function of biological neural networks. In some embodiments, the neural network that performs feature recognition on the areas of the entire target image may be a convolutional neural network. The convolutional neural network may have higher accuracy in the feature recognition on the entire area of the target image.

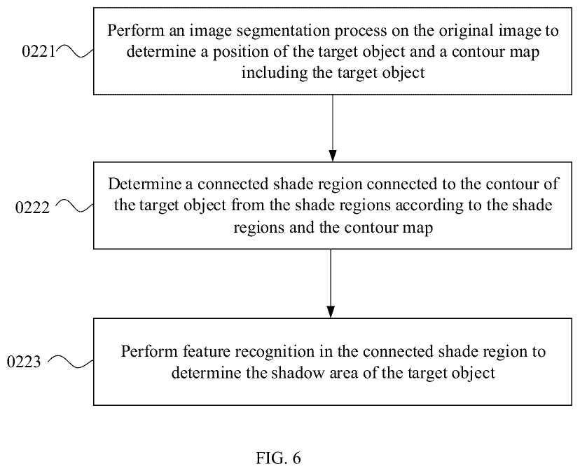

In some embodiments, as shown in FIG. 6, 022 includes:
0221: performing an image segmentation process on the original image 300 to determine a position of the target object and a contour map including the target object;
0222: based on the shade regions and the contour map, determining connected shade regions that are connected to the contour of the target object in the shade regions; and
0223: performing feature recognition on the connected shade regions to determine the shadow area 301 of the target object.

In some embodiments, the above steps may be implemented by the image processing apparatus 100. That is, the processor 101 may be configured to: perform the image segmentation process on the original image 300 to determine the position of the target object and the contour map including the target object; based on the shade regions and the contour map, determine the connected shade regions that are connected to the contour of the target object in the shade regions; and perform feature the recognition on the connected shade regions to determine the shadow area 301 of the target object. By the image segmentation process and the feature recognition of the connected shade regions, the shadow area 301 of the target object may be determined quickly, making the processing method more efficient.

The feature recognition may include two recognition methods. One feature recognition method is to directly perform feature recognition on all shade regions of the target image (that is, as described in the previous embodiment). Another method provided by this embodiment may include: first performing the image segmentation process on the original image 300 to determine the position of the target object and the contour map including the target object; determining the connected shade regions in the shade regions that are connected to the contour of the target object, and performing feature recognition on the connected shade regions to determine the shadow area 301 of the target object.

In one embodiment, the target object may include the photographing device and the support apparatus of the photographing device. The photographing device may be a sports camera, and the support apparatus may be a selfie stick. The sports camera may be mounted on the selfie stick, and the user may hold the selfie stick. The image segmentation process may be first performed on the original image 300 to determine the position of the sports camera, the position of the selfie stick of the sports camera, or the position of the user holding the selfie stick, to obtain the contour map of the sports camera, the selfie stick of the sports camera, or the user holding the selfie stick. In the contour map, only the contour of the sports camera, the selfie stick of the sports camera, or the user holding the selfie stick may be retained. Then, the connected shade regions connected to the contour map of the sports camera, the selfie stick of the sports camera, or the user holding the selfie stick may be determined from the shade regions. The feature recognition may be performed on the connected shade regions connected to the contour map of the sports camera, the selfie stick of the sports camera, or the user holding the selfie stick.

In some embodiments, the image segmentation process may include semantic segmentation or example segmentation.

Semantic segmentation may be classification at the pixel level. An object category to which each pixel in the original image 300 belongs may be marked, and pixels belonging to a same type may be grouped into a same category. In one embodiment, semantic segmentation may classify each pixel in the original image 300 and determine the category of each pixel. The category of each pixel may be background, edge, contour, user body, etc. Example segmentation may be understood as a combination of target detection and semantic segmentation. Example segmentation may be accurate to the edge of an object. Compared with semantic segmentation, example segmentation may be able to mark different individuals of a same object on the original image 300.

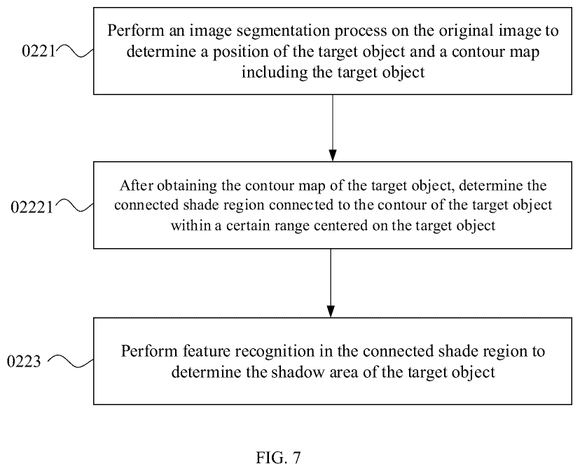

In some embodiments shown in FIG. 7, 0222 includes:
02221: after obtaining the contour map of the target object, determining the connected shade regions connected to the contour of the target object in a certain range with the target object as a center.

In some embodiments, the above steps may be implemented by the image processing apparatus 100. That is, the processor 101 may be configured to: after obtaining the contour map of the target object, determining the connected shade regions connected to the contour of the target object in the certain range with the target object as the center. Therefore, by determining the connected shade regions connected to the contour of the target object in the certain range with the target object as the center through the contour map of the target object, the shadow area of the target object may be initially determined quickly, reducing the computing amount of the processor 101.

In one embodiment, the contour map of the target object may refer to the contour map of the sports camera and the selfie stick in the original image 300, not the contour map of the shadow area. The sports camera and selfie stick in the original image 300 may be understood as target object. After obtaining the contour of the target object, the connected shade regions connected to the contour of the target object may be determined within the certain range centered on the target object. And the feature recognition may be performed on the connected shade regions connected with the contour of the target object. Therefore, the shadow area of the target object may be initially determined quickly, reducing the computing amount of the processor 101. The certain range may be predetermined based on the length of commonly used selfie sticks and the size of the photographing device.

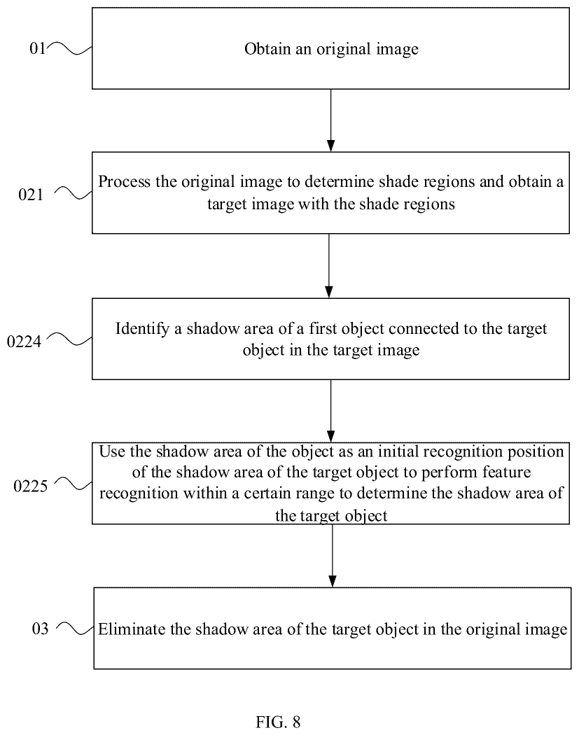

In some embodiments, as shown in FIG. 8, 022 includes:
0224: identifying a shadow area 301 of a first object connected to the target object in the target image; and
0225: using the shadow area 301 of the first object as the initial recognition position of the shadow area 301 of the target object, and performing the feature recognition within a certain range to determine the shadow area 301 of the target object.

In some embodiments, the above steps may be implemented by the image processing apparatus 100. That is, the processor 101 may be configured to: identify the shadow area 301 of the first object connected to the target object in the target image; and use the shadow area 301 of the first object as the initial recognition position of the shadow area 301 of the target object, to perform feature recognition within the certain range to determine the shadow area 301 of the target object. Therefore, the shadow area of the target object may be initially determined quickly, reducing the computing amount of the processor 101.

In one embodiment, the first object connected to the target object may be a hand of a human body. The human body may include, but is not limited to, a head, a limb, a joint or another part. In one embodiment, the target object may include the photographing device and the support apparatus of the photographing device. The support apparatus may be a selfie stick, the photographing device may be the sports camera, and the sports camera may be installed on one end of the selfie stick. The user's hand may hold another end of the selfie stick. Therefore, the shadow area of the user's hand may be identified in the target image. Using the shadow area of the hand as the initial position, the feature recognition may be performed within the certain range to determine the shadow area 301 of the sports camera and selfie stick.

In another embodiment, the first object connected to the target object may be a head of a human body, the target object may include the photographing device and the support apparatus for the photographing device, the support apparatus may be a head-mounted device, and the photographing device may be a sports camera. The sports camera may be attached to the head-mounted device that the user wears on the head. Therefore, the shadow area 301 of the user's head may be identified in the target image. Taking the shadow area 301 of the head as the initial position, the feature recognition may be performed within the certain range to determine the shadow area 301 of the sports camera and the head-mounted device.

In other embodiments, the first object may also be other objects, such as ground, stones, walls, or other objects that are able to support or install the support apparatus.

In some embodiments, 02224 may include:
performing feature recognition on at least two key features of a second object in the original image 300;
determining a mapping relationship between the physical positions and shadow position of the at least two key features based on the physical positions and shadow positions of the at least two key features of the second object; and
determining the shadow area 301 of the first object in the target image according to the physical position of the first object and the mapping relationship, where the first object is a part of the second object.

In some embodiments, the above steps may be implemented by the image processing apparatus 100. That is, the processor 101 may be configured to: perform feature recognition on the at least two key features of the second object in the original image 300; determine the mapping relationship between the physical positions and shadow positions of the at least two key features based on the physical positions and shadow positions of the at least two key features of the second object; and determining the shadow area 301 of the first object in the target image according to the physical position of the first object and the mapping relationship. The first object may be a part of the second object. By performing feature recognition on the at least two key features, more accurate recognition results may be obtained, avoiding misrecognition in the recognition process. Also, by determining the shadow area 301 of the objects through the mapping relationship, the determination accuracy may be improved.

In one embodiment, the at least two key features of the second object in the original image 300 may be identified. In one embodiment, the second object in the original image 300 may include a human body, and the at least two key features of the human body may include hands, heads, joints, etc. After performing feature recognition on the at least two key features, for example, after recognizing the head and the shoulder, the physical positions and shadow positions of the key features may be determined. And then, based on the physical positions and the shadow positions of the key features, the mapping relationship between the physical positions and the shadow positions of the key features may be established. The shadow area 301 of the first object may be determined based on the mapping relationship and the physical position of the first object. Therefore, the shadow area 301 of the first object may be determined quickly and accurately through the at least two key features and the physical position of the first object.

In one embodiment, the second object may be the human body, and the first object may be the human body's hand. In the original image 300, the key features such as the human body's head, shoulders, joints, etc. may be recognized to identify the physical positions and the shadow positions of these key features in the original image 300. According to the physical positions and shadow positions of these key features in the original image 300, the mapping relationship between the physical positions and the shadow positions of these key features in the original image 300 may be determined. For example, the mapping relationship may include the relationship between the angles and directions of the physical positions and the shadow positions. That is, the direction from which the light shines to form a shadow may be determined. Since in a same scenario, the angle of the light irradiation usually shows a certain pattern, and the mapping relationship also shows inherent rules according to the irradiation angle of the light. For example, when there is a parallel light source, the mapping relationship may be determined based on the angle at which the parallel light source illuminates the human body. When there is a point light source, angles between the light with different angles and each key feature of the human body may be determined according to the distance and angle of the point light source with respect to the human body, to determine the mapping relationship. Therefore, the mapping relationship can be determined based on the key features of the human body, and then the shadow area 301 of the hand may be determined based on the physical position of the hand of the human body and the mapping relationship.

In some embodiments, the image processing method may further include: after identifying the shadow area 301 of the target object, verifying the shadow area 301 of the target object.

The image processing method in the present embodiment may be implemented by the image processing apparatus 100. The processor 101 may be configured to: after identifying the shadow area 301 of the target object, verify the shadow area 301 of the target object.

In one embodiment, after identifying the shadow area 301 of the target object, the edge features of the shadow area 301 may be obtained. If the edge features conform to the shadow features formed by the physical shape of the target object, the shadow area 301 may be considered to be correct. Otherwise, the identified shadow area 301 may not be accepted.

In one embodiment, the target object may be a selfie stick, and the shadow features formed by the physical shape of the selfie stick may include that the edge features are basically on a straight line and the length of the shadow area 301 is larger than a length threshold and the width is less than a width threshold. When the shadow area 301 of the target object recognized in the original image 300 conforms to the above features, the shadow area 301 may be considered to be recognized correctly, otherwise the recognized shadow may not be accepted.

The length threshold and width threshold may be determined at a certain ratio based on the length and width of the selfie stick itself. The ratio may be calibrated in advance. For example, the appropriate value of the ratio may be selected based on the test results. The specific values are not limited here.

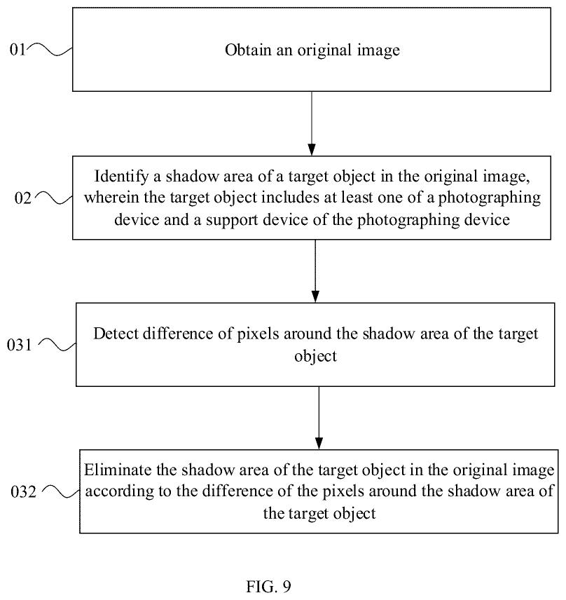

In some embodiment as shown in FIG. 9, 03 includes:
031: detecting difference of pixels around the shadow area 301 of the target object; and
032: eliminating the shadow area 301 of the target object in the original image 300 according to the difference of the pixels around the shadow area 301 of the target object.

The image processing method in the present embodiment may be implemented by the image processing apparatus 100. The processor 101 may be configured to: detect the difference of the pixels around the shadow area 301 of the target object; and eliminate the shadow area 301 of the target object in the original image 300 according to the difference of the pixels around the shadow area 301 of the target object. Therefore, the pixels around the shadow area 301 in the original image 300 after the shadow area 301 is eliminated may be more coordinated, to avoid obvious erasure traces.

In one embodiment, the difference of pixels around the shadow area 301 of the target object may be determined based on the difference in color or brightness between adjacent pixels around the shadow area 301 of the target object, and then the shadow area 301 of the target object in the original image 300 may be eliminated based on the difference. Therefore, the shadow area 301 of the target object may be eliminated based on the difference of pixels around the shadow area 301 of the target object in the original image 300 of the same frame. The pixels around the shadow area 301 in the original image 300 after the shadow area 301 has been eliminated may be more coordinated, to avoid obvious erasure traces.

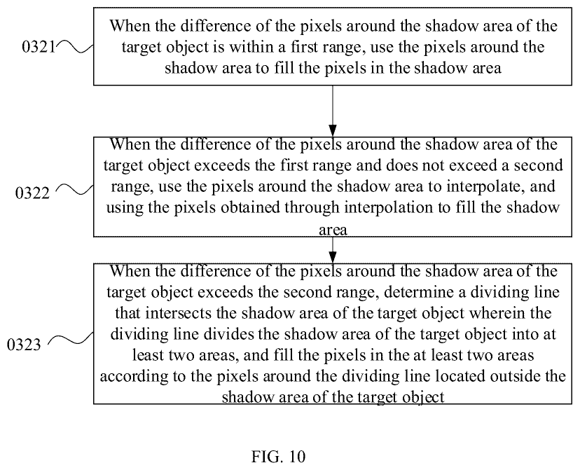

In some embodiments, as shown in FIG. 10, 032 may include:
0321: using the pixels around the shadow area 301 to fill the pixels of the shadow area 301 when the difference of the pixels around the shadow area 301 of the target object is within a first range;
0322: when the difference of the pixels around the shadow area 301 of the target object exceeds the first range and does not exceed a second range, performing interpolation using the pixels around the shadow area 301, and filling the shadow area 301 with pixels obtained after interpolation; and
0323: when the difference of the pixels around the shadow area 301 of the target object exceeds the second range, determining a dividing line intersecting the shadow area 301 of the target object and dividing the shadow area 301 of the target object into at least two areas, and filling pixels in the at least two areas according to pixels located around the dividing line outside the shadow area 301 of the target object.

The image processing method in the present embodiment may be implemented by the image processing apparatus 100. The processor 101 may be configured to: use the pixels around the shadow area 301 to fill the pixels of the shadow area 301 when the difference of the pixels around the shadow area 301 of the target object is within a first range; when the difference of the pixels around the shadow area 301 of the target object exceeds the first range and does not exceed a second range, perform interpolation using the pixels around the shadow area 301, and fill the shadow area 301 with pixels obtained after interpolation; and when the difference of the pixels around the shadow area 301 of the target object exceeds the second range, determine a dividing line intersecting the shadow area 301 of the target object and dividing the shadow area 301 of the target object into at least two areas, and fill pixels in the at least two areas according to pixels located around the dividing line outside the shadow area 301 of the target object. Therefore, the shadow area 301 may be eliminated.

In one embodiment, when the difference of the pixels around the shadow area 301 of the target object is within a first range, the pixels (such as gray values of the pixels) around the shadow area 301 of the target object may be basically the same, and the pixels in the shadow area 301 may be also basically the same as the surrounding pixels when the shadow does not exist. Therefore, the pixels around the shadow area 301 may be directly used to fill the pixels in the shadow area 301. For example, when the shadow area 301 falls on an object such as a solid-color floor or wall, the shadow area 301 may be removed by directly filling the shadow area 301 with a color of a solid-color floor or wall.

When the difference of the pixels around the shadow area 301 of the target object exceeds the first range and does not exceed a second range, the pixels around the shadow area 301 of the target object may be relatively similar, and the shadow area 301 may be also relatively similar to its surrounding pixels (such as gray values of the pixels) under normal circumstances without a shadow. Therefore, the pixels surrounding the shadow area 301 may be used for interpolation, and the shadow area 301 may be filled with the pixels obtained after interpolation. As shown in FIG. 2, in one embodiment, the difference of the pixels around the shadow area 301 between the arrow 3 and the arrow 4 exceeds the first range and does not exceed the second range. Therefore, the pixels at two sides of the arrow 1 and the arrow 2 ma be used for interpolation and the shadow area 301 between the arrow 1 and the arrow 2 may be filled with the interpolated pixels. In one embodiment, the pixels around the shadow area 301 may be averaged, and then the shadow area 301 may be filled with the average value. For example, when the shadow area 301 falls on clothes with gradient colors or objects with similar colors, the pixels around the shadow area 301 may be averaged, and then the average value may be used to fill the shadow area 301 to eliminate the shadow area 301.

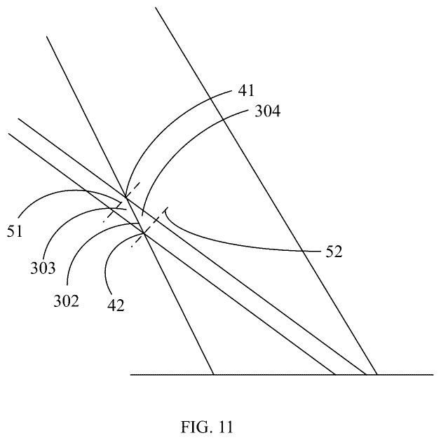

When the difference of the pixels around the shadow area 301 of the target object exceeds the second range, the pixels around the shadow area 301 of the target object may have relatively obvious differences. Different positions of the shadow area 301 may correspond to the pixels around the positions when there is no shadow. Therefore, the dividing line crossing the shadow area 301 may be determined. The dividing line may divide the shadow area 301 into the at least two areas, and the pixels in the at least two areas may be filled according to the pixels located around the dividing line outside the shadow area 301. In one embodiment, the difference between the pixels around the shadow area 301 between the arrow 3 and the arrow 4 and the pixels around the shadow area 301 in the circle exceeds the second range. As shown in FIG. 11, the dividing line 302 where the shadow area 301 intersects may be determined. In the example shown in FIG. 11, the dividing line 302 is a boundary of the road lane line, and the boundary of the road lane line intersects the shadow area 301. The dividing line 302 divides the shadow area 301 into two areas: a first area 303 and a second area 304. Because the pixels inside and outside the road lane lines are not the same, or the difference exceeds the second range, the pixels in the first area 303 and the pixels in the second area 304 may be filled according to the pixels around the boundary outside the shadow area. For example, when the shadow area 301 falls on different objects, such as when the shadow area 301 falls on green grass and yellow soil respectively, the dividing line 302 intersecting the shadow area 301 may be determined. The dividing line 302 may divide the shadow area 301 into a first area 303 corresponding to the grass and a second area 304 corresponding to the soil. The first area 303 may be filled according to the color of the grass, and the second area 304 may be filled according to the color of the soil, thereby eliminating the shadow area 301.

In one embodiment, the two boundaries between the dividing line 302 and the shadow area 301 may form a first intersection point 41 and a second intersection point 42. A direction passing through the first intersection point 41 and perpendicular to the length direction of the shadow area 301 may be determined as a first perpendicular line 51, and a direction passing through the second intersection point 42 and perpendicular to the length direction of the shadow area 301 may be determined as the first vertical line 52. The first area 303 may be determined by the first vertical line 51, one corresponding boundary of the shadow area 301 and the dividing line 302. The first area 303 may be filled by the pixels around the dividing line 302 outside the shadow area. The pixels around the dividing line 302 outside the shadow area 301 may be located outside the lane dividing line.

The second area 304 may be determined by the second vertical line 52, another boundary of the shadow area 301 and the dividing line 302. The second area 304 may be filled by the pixels around the dividing line 302 outside the shadow area 301. The pixels surrounding the dividing line 302 outside the shadow area 301 are located within the lane dividing line.

In one embodiment, the pixels around the shadow area 301 may be selected based on pre-calibration. For example, a boundary of each side may be selected on two sides of the shadow area 301, and the pixels covered by a width of half of the shadow area may be regarded as the pixels surrounding the shadow area 301.

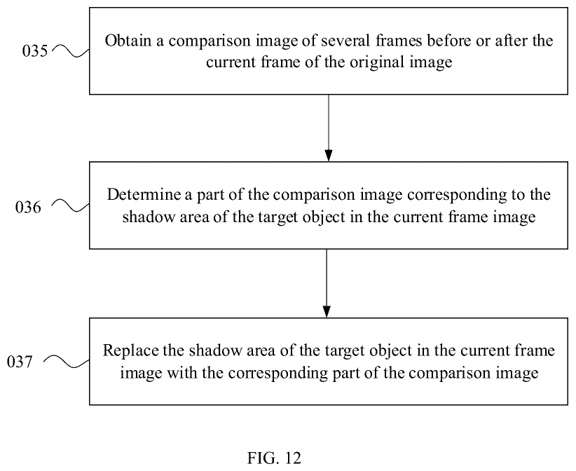

In some embodiments, as shown in FIG. 12, 03 includes:
035: obtaining a comparison image of several frames before or after the current frame of the original image 300;
036: determining the corresponding part of the comparison image corresponding to the shadow area 301 of the target object of the current frame image; and
037: using the corresponding part of the comparison image to replace the shadow area 301 of the target object of the current frame image.

The image processing method in the present embodiment may be implemented by the image processing apparatus 100. The processor 101 may be configured to: obtain the comparison image of several frames before or after the current frame of the original image 300; determine the corresponding part of the comparison image corresponding to the shadow area 301 of the target object of the current frame image; and use the corresponding part of the comparison image to replace the shadow area 301 of the target object of the current frame image.

For example, another comparison image different from the current frame image may be used to eliminate the shadow area 301 of the current frame image. In one embodiment, the comparison image may be several frames of images before the current frame image, or several frames of images after the current frame image. The comparison image of several frames before or after the current frame may include images whose photographing time is before or after the photographing time of the current frame image respectively, and the number of frames may be selected according to the preset. The preset may be the default setting or the setting set by the user. The posture of the subject being photographed may change. Because different photographing times, the current frame image and the comparison image may be different. The place covered by the shadow area 301 in the current frame image may not have a shadow in the comparison image. Therefore, the shadow area 301 of the current frame image may be replaced by the corresponding part in the comparison image corresponding to the shadow area 301 of the current frame image, such that the part corresponding to the shadow area 301 of the current frame image becomes a shadow-free situation, to eliminate the shadow area.

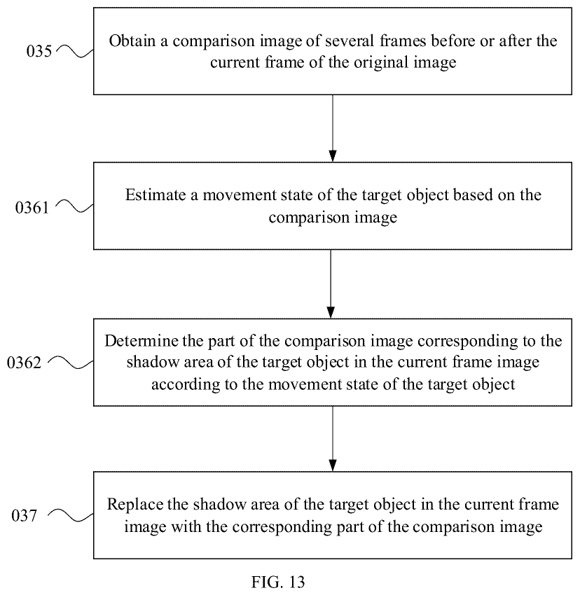

In some embodiments, as shown in FIG. 13, 036 includes:
0361: according to the comparison image, estimating the movement state of the target object; and
0362: according to the movement state of the target object, determining the corresponding part in the comparison image corresponding to the shadow area 301 of the target object in the current frame image.

The image processing method in the present embodiment may be implemented by the image processing apparatus 100. The processor 101 may be configured to: according to the comparison image, estimate the movement state of the target object; and, according to the movement state of the target object, determine the part in the comparison image corresponding to the shadow area 301 of the target object in the current frame image. Therefore, the part in the comparison image corresponding to the shadow area 301 of the target object in the current frame image may be determined quickly and accurately according to the movement state of the target object.

In one embodiment, the movement state of the target object may be estimated based on the different positions of the target object in the comparison image. For example, when the position of the target object in the comparison image changes, the target object may be determined to have the corresponding movement state. According to the movement state, the shadow area 301 of the target object in the current frame image may be determined to have undergone corresponding movement. Therefore, the part in the comparison image corresponding to the shadow area 301 of the target object in the current frame image may be determined according to the movement state.

In some embodiments, 0362 may include:
according to the movement state of the target object, determining the movement speed and direction of the target object in the comparison image, and then determining the movement speed and direction of the target object's corresponding pixels in the comparison image; and
according to the movement speed and direction of the target object's corresponding pixels in the comparison image, determining the part in the comparison image corresponding to the shadow area 301 of the target object in the current frame image.

The image processing method in the present embodiment may be implemented by the image processing apparatus 100. The processor 101 may be configured to: according to the movement state of the target object, determine the movement speed and direction of the target object in the comparison image and then determine the movement speed and direction of the target object's corresponding pixels in the comparison image; and, according to the movement speed and direction of the target object's corresponding pixels in the comparison image, determine the part in the comparison image corresponding to the shadow area 301 of the target object in the current frame image. Therefore, the part in the comparison image corresponding to the shadow area 301 of the target object in the current frame image may be determined quickly and accurately according to the movement state of the target object.

In one embodiment, the movement state of the target object may include the movement speed and direction of the target object. According to the movement speed and direction of the target object, the movement speed and direction of the target object in the comparison image may be determined. For example, in an actual scenario, when the target object moves to the right at a first movement speed, the image part of the target object in the comparison image may move to the right at a second movement speed, where the second movement speed may correspond to the first movement speed. The second movement speed may be obtained according to the first movement speed and a mapping relationship. The mapping relationship may be obtained by pre-calibration. The first movement speed and direction may be obtained by an attitude sensor (such as an inertial sensor, an acceleration sensor, etc.). The attitude sensor may be installed on the photographing device, the image processing apparatus, or the support apparatus. According to the movement speed and direction of the image portion of the target object in the comparison image, the part in the comparison image corresponding to the shadow area 301 of the target object may be determined. In one example, the comparison image may be several frames before the current frame image, and the image part of the target object in the comparison image may move to the right at the second movement speed in the comparison image. Therefore, a part in the comparison image corresponding to the shadow area 301 of the target object moving to the right with the second movement speed may be determined to correspond to the shadow area 301 of the target object in the current frame image. Therefore, the part in the comparison image corresponding to the shadow area 301 of the target object in the current frame image may be determined quickly and accurately according to the movement state of the target object.

In some embodiments, 0362 may include:
when the corresponding part is included in a plurality of comparison images, merging the plurality of comparison images including the corresponding part.

The image processing method in the present embodiment may be implemented by the image processing apparatus 100. The processor 101 may be configured to: when the corresponding part is included in a plurality of comparison images, merge the plurality of comparison images including the corresponding part. The error may be reduced.

In one embodiment, the corresponding pixels of the plurality of comparison images including the corresponding part may be averaged to achieve merging. The merged pixel average values may be used to replace the shadow area 301 of the target object in the current frame image. Therefore, the possible error of one single comparison image may be reduced. The corresponding part of the comparison images may be more accurate, thereby making the current frame image after eliminating the shadow area 301 more accurate.

In some embodiments, 036 may include:
finding a corresponding identifier in the current frame image according to the shadow area 301 of the target object; and
determining the part in the comparison image corresponding to the shadow area 301 of the target object in the current frame image according to the corresponding identifier.

The image processing method in the present embodiment may be implemented by the image processing apparatus 100. The processor 101 may be configured to: find the corresponding identifier in the current frame image according to the shadow area 301 of the target object; and determine the part in the comparison image corresponding to the shadow area 301 of the target object in the current frame image according to the corresponding identifier. Therefore, the identifier of the shadow area 301 may be used to determine the corresponding part in the comparison image accurately.

In one embodiment, the identifier corresponding to the shadow area 301, such as the edge points, text, bulges, depressions or other marks in the shadow area 301, may be searched for in the current frame image. And then, the part in the comparison image corresponding to the shadow area 301 of the target object in the current frame image may be determined according to the corresponding identifier. For example, in one embodiment, there may be a protrusion of a specific shape in the shadow area 301 of the current frame image. The protrusion of the specific shape may be determined in the comparison image, and the corresponding part in the comparison image corresponding to the shadow area 301 of the current frame image may be determined based on the protrusion.

In some embodiments, the image processing method may further include:
obtaining a preset gesture and a hand holding the target object in the original image 300;
processing the preset gesture according to the hand holding the target object in the original image 300 to obtain the processed gesture; and
replacing the hand holding the target subject in the original image 300 with the processed gesture.

The image processing method in the present embodiment may be implemented by the image processing apparatus 100. The processor 101 may be configured to: obtain the preset gesture and the hand holding the target object in the original image 300; process the preset gesture according to the hand holding the target object in the original image 300 to obtain the processed gesture; and replace the hand holding the target subject in the original image 300 with the processed gesture. Therefore, the processed gesture may be more natural and the original holding gesture may be avoided.

In one embodiment, the preset gesture may be stored in advance. After obtaining the preset gesture and the hand holding the target object in the original image 300, the preset gesture may be processed according to the hand holding the target object in the original image 300. For example, the angle, color, or brightness of the preset gesture may be adjusted according to the angle, color, or brightness of the hand holding the target object in the original image 300, to obtain the processed gesture. In one embodiment, the angle, color or brightness of the processed gesture may be basically consistent with the angle, color or brightness corresponding to the hand holding the target object in the original image 300. The processed gesture may be used to replace the hand holding the target object in the original image 300. Therefore, the processed gesture may be more natural and the original holding gesture may be avoided.

In some embodiments, the image processing method may include:
obtaining a hand area holding the target object in the original image 300; and
blurring the hand area.

The image processing method in the present embodiment may be implemented by the image processing apparatus 100. The processor 101 may be configured to: obtain the hand area holding the target object in the original image 300; and blur the hand area.

By blurring the hand area, the hand area can be blurred, such that the presence of the hand area may be diluted and other areas of the original image 300 may be more obvious and prominent, thereby enhancing the layering of the original image 300.

In some embodiments, the image processing method may include:
determining a coverage part that matches the original image 300; and
using the coverage part to cover the shadow area 301 of the target object.

The image processing method in the present embodiment may be implemented by the image processing apparatus 100. The processor 101 may be configured to: determine the coverage part that matches the original image 300; and use the coverage part to cover the shadow area 301 of the target object. Therefore, the aesthetics of the image may be improved, such that photographed image may not appear obtrusive.

In one embodiment, the coverage part may be, for example, an image, text, special effect, etc., that matches the original image 300. The coverage part may be used to cover the shadow area 301, such that the shadow area 301 of the target object does not appear in the original image 300 and the original image may be more fun.

The present disclosure also provides a photographing device. The photographing device may include an image processing apparatus provided by various embodiments of the present disclosure.

In the present disclosure, the photographing device may eliminate the shadow area 301 of the target object in the original image 300 where the target object may include at least one of the photographing device or the support apparatus of the photographing device, the image without the shadow area 301 of the target object may be obtained. When the original image 300 does not contain the target object, the aesthetics of the image may be improved, such that the photographing image may not appear obtrusive, and the photographing effect that is not a self-portrait picture may be improved.

In one embodiment, the photographing device may include, but is not limited to, a mobile phone, a gimbal camera, a tablet, a camera (including sports cameras), etc. The gimbal camera may be installed on a gimbal handle, and a part of the gimbal handle may be able to be unfolded or extended to form the support apparatus.

The present disclosure also provides a computer-readable storage medium. The computer-readable storage medium may be configured to store several computer instructions. When the computer instructions are executed by a processor, an image processing method provided by various embodiments of the present disclosure may be implemented.

In the present disclosure, the computer-readable storage medium may eliminate the shadow area 301 of the target object in the original image 300 where the target object may include at least one of the photographing device or the support apparatus of the photographing device, the image without the shadow area 301 of the target object may be obtained. When the original image 300 does not contain the target object, the aesthetics of the image may be improved, such that the photographing image may not appear obtrusive, and the photographing effect that is not a self-portrait picture may be improved.

In the present disclosure, terms such as “certain embodiments,” “one embodiment,” “some embodiments,” “illustrative embodiments,” “examples,” “specific examples” or “some examples,” mean that a specific feature, structure, material or characteristic described in connection with the embodiments or examples is included in at least one embodiment or example of the present disclosure. In the present disclosure, schematic representations of the above terms do not necessarily refer to the same embodiment or example. Furthermore, the specific features, structures, materials or characteristics described may be combined in any suitable manner in any one or more embodiments or examples.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure.

1-46. (canceled)

47. An image processing method comprising:
obtaining an original image;
identifying a shadow area of a target object in the original image, wherein the target object includes at least one of a photographing device or a support apparatus of the photographing device; and
eliminating the shadow area of the target object in the original image.

48. The image processing method according to claim 47, wherein:
obtaining the original image includes obtaining the original image from the photographing device.

49. The image processing method according to claim 47, wherein identifying the shadow area of the target object in the original image includes:
processing the original image to determine one or more shade regions and obtain a target image with the one or more shade regions; and
performing feature recognition on the one or more shade regions to determine the shadow area of the target object.

50. The image processing method according to claim 49, wherein processing the original image to determine the shade regions and obtain the target image with the shade regions includes:
processing the original image using a simplification process to determine the one or more shade regions.

51. The image processing method according to claim 50, wherein the simplification process includes a binarization process.

52. The image processing method according to claim 49, wherein performing the feature recognition on the at least one shade regions to determine the shadow area of the target object includes:
performing the feature recognition on an entire area of the target image to determine the shadow area of the target object; or
performing an image segmentation process on the original image to determine a position of the target object and a contour map including the target object, determining a connected shade region connected to the contour of the target object from the at least one shade regions according to the at least one shade regions and the contour map, and performing the feature recognition on the connected shade region to determine the shadow area of the target object.

53. The image processing method according to claim 52, wherein the image segmentation process includes semantic segmentation or example segmentation.

54. The image processing method according to claim 52, wherein determining the connected shade region includes:
after obtaining the contour map of the target object, determining the connected shade region connected to the contour of the target object within a certain range centered on the target object.

55. The image processing method according to claim 49, wherein performing the feature recognition on the at least one shade regions to determine the shadow area of the target object includes:
identifying a shadow area of a first object connected to the target object in the target image; and
using the shadow area of the first object as an initial recognition position of the shadow area of the target object to perform the feature recognition within a certain range to determine the shadow area of the target object.

56. The image processing method according to claim 55, wherein identifying the shadow area of the first object includes:
identifying at least two key features of a second object in the original image, the first object being a part of the second object;
according to physical positions and shadow positions of the at least two key features of the second object, determining a mapping relationship between the physical positions and shadow positions of the key features; and
based on the mapping relationship and a physical position of the first object, determining the shadow area of the first object in the target image.

57. The image processing method according to claim 56, wherein the second object includes a human body, and the first object includes a hand of the human body.

58. The image processing method according to claim 47, wherein eliminating the shadow area of the target object in the original image includes:
detecting difference of pixels around the shadow area of the target object; and
eliminating the shadow area of the target object in the original image according to the difference of the pixels around the shadow area of the target object.

59. The image processing method according to claim 58, wherein eliminating the shadow area of the target object in the original image according to the difference of the pixels around the shadow area of the target object includes:
in response to the difference being within a first range, filling pixels in the shadow area using the pixels around the shadow area; or
in response to the difference exceeding the first range and not exceeding a second range, performing interpolation using the pixels around the shadow area, and performing filling in the shadow area using pixels obtained through the interpolation; or
in response to the difference exceeding the second range, determining a dividing line that intersects the shadow area of the target object and divides the shadow area of the target object into at least two areas, and filling the pixels in the at least two areas according to pixels around the dividing line located outside the shadow area of the target object.

60. The image processing method according to claim 47, wherein eliminating the shadow area of the target object in the original image includes:
obtaining a comparison image of several frames before or after a current frame of the original image;
determining a corresponding part of the comparison image corresponding to the shadow area of the target object in the current frame image; and
replacing the shadow area of the target object in the current frame image with the corresponding part of the comparison image.

61. The image processing method according to claim 60, wherein determining the corresponding part of the comparison image includes:
searching for a corresponding identifier in the current frame image according to the shadow area of the target object; and
determining the corresponding part of the comparison image in the current frame image according to the corresponding identifier.

62. The image processing method according to claim 47, further comprising:
obtaining a preset gesture and a hand holding the target object in the original image;
processing the preset gesture according to the hand holding the target object in the original image to obtain a processed gesture; and
replacing the hand holding the target object in the original image with the processed gesture.

63. The image processing method according to claim 47, further comprising:
obtaining a hand area holding the target object in the original image; and
blurring the hand area.

64. The image processing method according to claim 47, wherein eliminating the shadow area of the target object in the original image includes:
determining a covering part that matches the original image; and
covering the shadow area of the target object using the covering part.

65. An image processing apparatus comprising:
at least one processor; and
at least one memory including computer program code, where the at least one memory and the computer program code are configured, with the at least one processor, to cause the apparatus to at least:
obtain an original image;
identify a shadow area of a target object in the original image, wherein the target object includes at least one of a photographing device or a support apparatus of the photographing device; and
eliminate the shadow area of the target object in the original image.

66. A photographing device comprising:
an image processing apparatus including:
at least one processor; and
at least one memory including computer program code, where the at least one memory and the computer program code are configured, with the at least one processor, to cause the apparatus to at least:
obtain an original image;
identify a shadow area of a target object in the original image, wherein the target object includes at least one of a photographing device or a support apparatus of the photographing device; and
eliminate the shadow area of the target object in the original image.
